(19) United States
(12) Patent Application Publication
(10) Pub. No.: US 2013/0297485 A1
(43) Pub. Date: Nov. 7, 2013

(54) Crowd-Sourced Credit Rating and Debt Tracking System to Facilitate Small Purchases on Trust Based Credit

(71) Applicant: Stephen Whitney, Dublin (IE)

(72) Inventor: Stephen Whitney, Dublin (IE)

(73) Assignee: MasterCard International Incorporated, Purchase, NY (US)

(21) Appl. No.: 13/460,992

(22) Filed: May 1, 2012

(51) Int. Cl. G06Q 40/02

(52) U.S. Cl. 705/38

(57) ABSTRACT

Systems and methods are provided for facilitating transactions between consumers and merchants on trust based credit. The systems and methods described herein enable a series of operations whereby a purchaser can initiate a transaction and instead of paying using a credit card or cash, the consumer can use trust based credit “tab” with the merchant and pay its bill at a later time. Based on this selection, a credit transaction request (identifying the consumer, the merchant and the credit amount) can be transmitted to the system server. In response, the system server can generate a report with the consumer's credit transaction history and credit profile and transmit the information back to the merchant. The merchant can elect to approve and finalize the credit transaction or decline. The consumer's transaction history can be updated with the transaction and all necessary adjustments to the consumer's credit profile can be made.

### TECHNICAL FIELD OF THE INVENTION

This patent application relates generally to the field of credit transactions and, in particular, a credit rating and debt tracking system to facilitate small purchases on trust based credit.

### BACKGROUND OF THE INVENTION

Carrying cash currency for daily, small purchases can be inconvenient: It requires the physical possession of coins or notes—which can be lost; it requires the location of use of and provision of infrastructure and services for the obtainment of cash—for example, banks and ATMs; and it is not always possible or convenient to obtain cash.

Using cash can reduce the visibility of the purchases made by consumers as the recording of the transaction must managed manually by the consumer. The process of using a credit/debit card for small daily purchases is also inconvenient as it may require the holder to enter personal or credit/debit card identification numbers and to verify their identity.

Purchasing with credit/debit cards eliminates the requirement to carry cash. However, as merchants are charged fees for processing credit/debit card transactions the fee charged can reduce or even outweigh the profit made from the sale, especially in the case of small transactions. As such, many merchants impose a lower bound on credit/debit card transactions, accept credit/debit card transactions and incur a loss, or refuse credit/debit card transactions outright (for example, merchants for whom the majority of transactions are small). In addition, the input of a credit/debit card can be inconvenient as it may require the holder to enter personal or credit/debit card identification numbers and to verify their identity.

Some merchants offer to run a ‘tab’ to trusted customers which allow the customer to obtain goods/services without paying for them immediately and instead pay the debt recorded by the merchant periodically. The settling of a tab with a merchant can still require the use of cash. The recording of tabs must be performed by the merchant, manually or using a computer system. The trust established between a customer and a merchant offering that customer a tab is not transferable. That is, the customer cannot avail himself of the same trust to establish a tab with another merchant, as the other merchant has no indication to the credit-worthiness of the customer. This requires the consumer to use some other payment method with other merchants and/or may act as a prohibiter to the customer obtaining goods/services from other merchants.

Accordingly, it is desirable to have a system whereby from the consumer's standpoint the system removes the inconvenience of carrying cash for small, daily purchases; reduces the acceptance barrier for making purchases on credit; facilitates the processing of transactions below a merchant's lower bound on credit/debit card transactions; allows the consumer to leverage trust established with particular merchants with others; increases the visibility of purchases as the system tracks the consumer's purchases with each merchant or combination of the foregoing improvements.

It is also desirable to have a system whereby, from the merchant's standpoint, the system allows the offering of credit based on a widely and often sampled rating of a consumer's credit; allows the cost-effective processing of transactions below the merchant's lower bound on credit/debit card transactions, as consumers can pay their tab periodically; improves the relationship with the customer by offering credit based on trust of that customer and by automatically gathering data on the purchasing habits of that consumer; increases the likelihood of customer retention as the consumer feels trusted by the merchant; provides an incentive for consumers to purchase goods/services from the merchant as this credit is available from the merchant based on the trust established by the consumer with other merchants; allows setting the level of credit extended to consumers, based on their credit rating, to a level the merchant is willing to accept; or a combination of the foregoing.

It is with respect to these and other considerations that the disclosure made herein is presented.

### SUMMARY OF THE INVENTION

Technologies are presented herein in support of a system and method to facilitate and process transactions based on trust based credit.

According to a first aspect, a credit transaction processing system is provided having one or more processors configured to interact with a computer-readable storage medium and execute one or more software modules stored on the storage medium. The system includes a database module configured to: maintain account information stored in a database for one or more of a plurality of consumers including the particular consumer; generate a credit transaction event; update the account information corresponding to the particular consumer; and store the account information in the database. The system also includes an authorization module configured to: receive a credit transaction request from a remote computing device in response to an action by the particular consumer, the credit transaction request comprising a consumer identifier corresponding to the particular consumer, a merchant identifier corresponding to one or more of a plurality of merchants and a credit request amount; generate a transaction history report corresponding to the particular consumer in response to the credit transaction request; provide the transaction history report to the remote computing device; and receive an approval status for the credit transaction request.

The credit transaction processing system can further include a payment module configured to: receive an account payment request from a consumer computing device, the account payment request comprising the consumer identifier corresponding to the particular consumer; generate a transaction history report corresponding to the particular consumer in response to the account payment request; provide the transaction history report to the consumer computing device; receive payment instructions relating to the transaction history report; process the payment instructions. In addition the database module is further configured to: generate an account payment event; update the account information corresponding to the particular consumer; and store the account information in the database.

According to another aspect, a method for processing a credit transaction using a computing device is provided. The method comprising: receiving a credit transaction request at the computing device from a remote computing device in response to an action by a consumer, the credit transaction request comprising a consumer identifier corresponding to the consumer, a merchant identifier corresponding to one or more of a plurality of merchants and a credit request amount corresponding to the credit transaction; querying a database for account information corresponding to the consumer; generating a transaction history report corresponding to the consumer; providing the transaction history report to the remote computing device; receiving an approval status corresponding to the credit transaction from the remote computing device; generating a credit transaction event; updating the account information according to the credit transaction event; and storing the account information in the database.

The method for processing a credit transaction using a computing device can also include receiving an account payment request from a remote computing device, the account payment request comprising a consumer identifier corresponding to the consumer; providing a transaction history corresponding to the consumer in response to the account payment request; receiving payment instructions relating to the transaction history; and processing the payment instructions; generating a payment transaction event; updating the account information according to the payment transaction event; and storing the account information in the database.

These and other aspects, features, and advantages can be appreciated from the accompanying description of certain embodiments of the invention and the accompanying drawing figures and claims.

### BRIEF DESCRIPTION OF THE DRAWINGS

FIG. 1 is a high-level diagram illustrating an exemplary configuration of a credit transaction processing system;

FIG. 2 is a block diagram illustrating an exemplary configuration of a credit transaction processing system;

FIG. 3 is a flow diagram showing a routine that illustrates processing of a credit transaction with at least one embodiment disclosed herein;

FIG. 4 depicts a screenshot of an exemplary transaction history report in accordance with at least one embodiment disclosed herein;

FIG. 5 is a flow diagram showing a routine that illustrates processing of a credit transaction with at least one embodiment disclosed herein; and

FIG. 6 depicts a screenshot of an exemplary payment transaction history in accordance with at least one embodiment disclosed herein.

### DETAILED DESCRIPTION OF CERTAIN EMBODIMENTS OF THE INVENTION

By way of overview and introduction, various systems and methods are described herein that facilitate and enable a credit rating and debt tracking system to facilitate small purchases on trust based credit.

It can be appreciated that from the consumer's standpoint there is a demand for a system that removes the inconvenience of carrying cash for small, daily purchases; reduces the acceptance barrier for making purchases on credit; facilitates the processing of transactions below a merchant's lower bound on credit/debit card transactions; allows the consumer to leverage trust established with particular merchants with others; and/or increases the visibility of purchases as the system tracks the consumer's purchases with each merchant.

It is also desirable from the merchant's standpoint for a system that allows the offering of credit based on a widely and often sampled rating of a consumers credit; allows the cost-effective processing of transactions below the merchant's lower bound on credit/debit card transactions, as consumers can pay their tab periodically; improves the relationship with the customer by offering credit based on trust of that customer and by automatically gathering data on the purchasing habits of that consumer; increases the likelihood of customer retention as the consumer feels trusted by the merchant; provides an incentive for consumers to purchase goods/services from the merchant as this credit is available from the merchant based on the trust established by the consumer with other merchants; and/or allows setting the level of credit extended to consumers, based on their credit rating, to a level the merchant is willing to accept.

In an effort to facilitate small purchases on trust based credit, the systems and methods described herein enable a series of operations whereby a purchaser can initiate a transaction, such as at a restaurant, and instead of paying for such items using a credit card or cash can use an existing (or establish a new) trust based credit “tab” with the merchant and pay its bill at a later time. Based on this selection, a credit transaction request can be generated (identifying the consumer, the merchant and the credit amount) and transmitted to a system server. The system server can include a database that stores information about registered consumers and merchants, a record of credit transactions between the consumers and merchants, and credit profiles detailing each consumer's credit worthiness. Upon receipt of the credit transaction request, the system server can generate a report with the consumer's credit transaction history and credit profile and transmit the information back to the merchant. The merchant has the opportunity to review the consumer's credit transaction history and credit profile and can elect to approve and finalize the credit transaction or decline. The approval status is then transmitted to the system server which can then update the consumer's transaction history accordingly and make all necessary adjustments to the consumer's credit profile.

The system also provides a way for the consumer to pay for its open tabs with one or more merchants that were opened using the system. The consumer can connect to the system from a remote device. The system can provide information about all the open tabs that the consumer has with merchants. The consumer can elect to pay one or more of them. The system which has the banking information for each consumer and merchant, can process the consumer's payment instructions and facilitate payment of the open tabs. When a consumer pays his tabs on time, the consumer can build positive trust based credit. If a consumer fails to pay on time or if payment does not go through as a result of insufficient funds, the consumer's trust based credit can be negatively affected. The approval status is then transmitted to the system server which can then update the consumer's transaction history accordingly and make all necessary adjustments to the consumer's credit profile.

The following detailed description is directed to systems and methods for facilitating purchases on trust based credit. The referenced systems and methods are now described more fully with reference to the accompanying drawings, in which one or more illustrated embodiments and/or arrangements of the systems and methods are shown. The systems and methods are not limited in any way to the illustrated embodiments and/or arrangements as the illustrated embodiments and/or arrangements described below are merely exemplary of the systems and methods, which can be embodied in various forms, as appreciated by one skilled in the art. Therefore, it is to be understood that any structural and functional details disclosed herein are not to be interpreted as limiting the systems and methods, but rather are provided as a representative embodiment and/or arrangement for teaching one skilled in the art one or more ways to implement the systems and methods. Accordingly, aspects of the present systems and methods can take the form of an entirely hardware embodiment, an entirely software embodiment (including firmware, resident software, micro-code, etc.), or an embodiment combining software and hardware. One of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer. Furthermore, the terms and phrases used herein are not intended to be limiting, but rather are to provide an understandable description of the systems and methods.

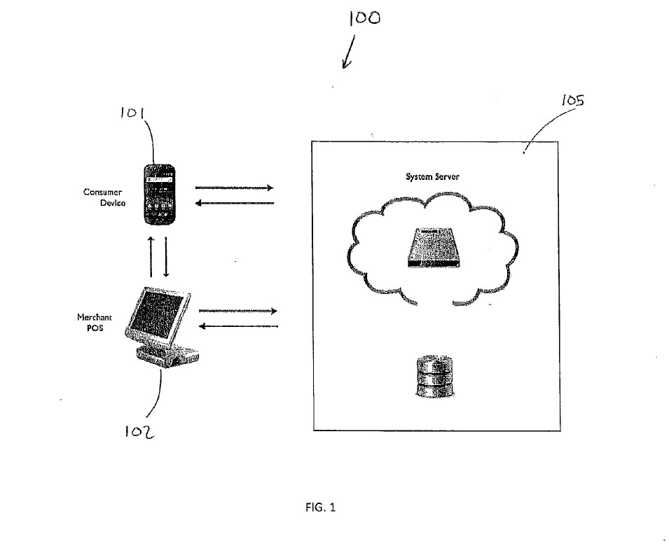

An exemplary system is shown as a block diagram in FIG. 1 which is a high-level diagram illustrating an exemplary configuration of a credit transaction processing system 100. In one arrangement, the system consists of a system server 105, at least one remote computing device 102 and a consumer device 101. It should be understood that system server 105 of credit transaction processing system 100 can be practically any computing device and/or data processing apparatus capable of embodying the systems and/or methods described herein.

The consumer device 101 can be used to identify the consumer to the merchant and initiate a trust based credit transaction with the credit transaction processing system 100. The consumer device 101 can be any device configured to communicate information about the consumer to the remote device 102, including but not limited to, a near field communication (NFC) enabled device, a Bluetooth enabled device, a QR code or barcode, a magnetic strip card or smart card. It should be understood that consumer device 101 is not ultimately necessary to provide consumer identification information to the credit transaction processing system 100 as a user can identify themselves securely in some other manner to a remote device 102 including keying in a secure identification number or password as discussed in further detail below.

Remote device 102 is used to collect information related to a transaction between a merchant and a consumer, communicate that information to the system server 105 and receive information relating to the credit transaction from the system server 105. It should be understood that remote device 102 can be any computing device and/or data processing apparatus capable of embodying the systems and/or methods described herein, including but not limited to a dedicated point of sale system, personal computer, tablet computers or smart phone device. Remote device 102 can be configured to read or receive consumer identity information from one or more of a variety of consumer devices 101 (i.e. if the consumer device 101 is a NFC device, the remote device 102 can include a NFC device reader; if the user input method is by a key code, the remote device can include a keypad or touch screen or other similar input device). A person of ordinary skill in the art would understand the various ways in which a consumer or merchant can identify themselves and how this information can be input into the remote device 102 either automatically or manually. Neither the consumer device 101 nor the merchant POS 102 form part of the present invention; they communicate with the system server 105 as described more fully next.

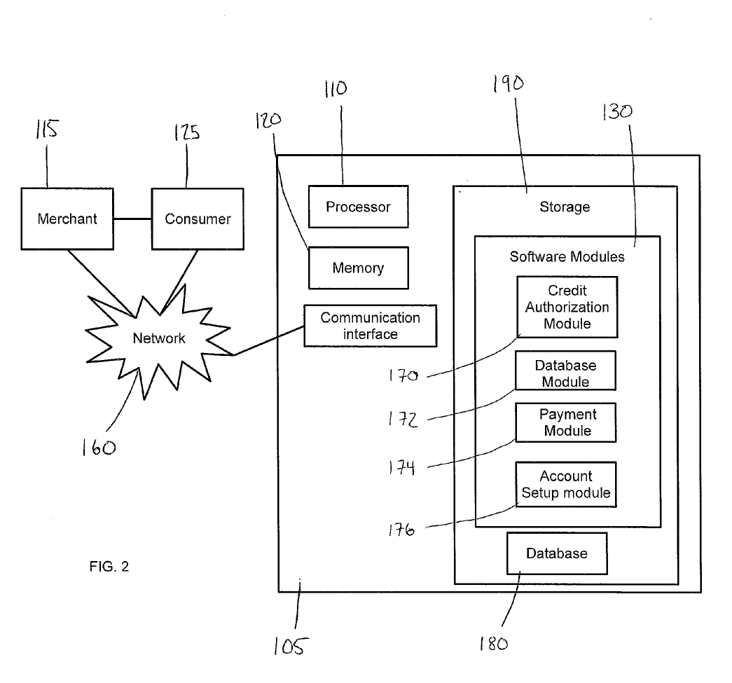

In reference to FIG. 2, system server 105 of credit transaction processing system 100 includes various hardware and software components that serve to enable operation of the credit processing system 100 including a processor 110, memory 120, storage 190 and a communication interface 150. Processor 110 serves to execute software instructions that can be loaded into memory 120. Processor 110 can be a number of processors, a multi-processor core, or some other type of processor, depending on the particular implementation. Further, processor 110 can be implemented using a number of heterogeneous processor systems in which a main processor is present with secondary processors on a single chip. As another illustrative example, processor 110 can be a symmetric multi-processor system containing multiple processors of the same type.

Preferably, memory 120 and/or storage 190 are accessible by processor 110, thereby enabling processor 110 to receive and execute instructions stored on memory 120 and/or on storage 190. Memory 120 can be, for example, a random access memory (RAM) or any other suitable volatile or non-volatile computer readable storage medium. In addition, memory 120 can be fixed or removable. Storage 190 can take various forms, depending on the particular implementation. For example, storage 190 can contain one or more components or devices such as a hard drive, a flash memory, a rewritable optical disk, a rewritable magnetic tape, or some combination of the above. Storage 190 also can be fixed or removable.

One or more software modules 130 are encoded in storage 190 and/or in memory 120. The software modules 130 can comprise one or more software programs or applications having computer program code or a set of instructions executed in processor 110. Such computer program code or instructions for carrying out operations for aspects of the systems and methods disclosed herein can be written in any combination of one or more programming languages. The program code can execute entirely on system server 105, partly on system server 105, as a stand-alone software package, partly on system server 105 and partly on a remote computer/device such as remote device 102 and/or consumer device 101, or entirely on the remote computer/device. In the latter scenario, the remote computer can be connected to system server 105 through any type of network, including a local area network (LAN) or a wide area network (WAN), or the connection can be made to an external computer (for example, through the Internet using an Internet Service Provider).

Preferably, included among the software modules 130 is a credit authorization module 170, a database module 172, a payment module 174 and an account setup module 176 that are executed by processor 110. During execution of the software modules 130, the processor 110 configures the system server 105 to perform various operations relating to the facilitating and processing of credit transaction, as will be described in greater detail below.

It can also be said that the program code of software modules 130 and one or more computer readable storage devices (such as memory 120 and/or storage 190) form a computer program product that can be manufactured and/or distributed in accordance with the present invention, as is known to those of ordinary skill in the art.

It should be understood that in some illustrative embodiments, one or more of software modules 130 can be downloaded over a network to storage 190 from another device or system via communication interface 150 for use within credit transaction processing system 100. In addition, it should be noted that other information and/or data relevant to the operation of the present systems and methods (such as database 180) can also be stored on storage 190, as will be discussed in greater detail below.

Also preferably stored on storage 190 is database 180. As will be described in greater detail below, database 180 contains and/or maintains various data items and elements that are utilized throughout the various operations of credit transaction processing system 100. The information stored in database 180 can include but is not limited to, merchant identifiers that are unique to each registered merchant (i.e. merchant 115), consumer identifiers that are unique to each registered consumer (i.e. consumer 125), personal information for each consumer, banking information for registered merchants and consumers, a credit profile for each consumer and a history of transactions between the consumers and merchants, as will be described in greater detail herein. It should be noted that although database 180 is depicted as being configured locally to system server 105, in certain implementations database 180 and/or various of the data elements stored therein can be located remotely (such as on a remote device or server—not shown) and connected to system server 105 through a network in a manner known to those of ordinary skill in the art.

Communication interface 150 is also operatively connected to the processor 110 and can be any interface that enables communication between the system server 105 and external devices, machines and/or elements including consumer device 101 and remote device 102. Preferably, communication interface 150 includes, but is not limited to, a modem, a Network Interface Card (NIC), an integrated network interface, a radio frequency transmitter/receiver (e.g., Bluetooth, cellular, NFC), a satellite communication transmitter/receiver, an infrared port, a USB connection, and/or any other such interfaces for connecting system server 105 to other computing devices and/or communication networks such as private networks and the Internet. Such connections can include a wired connection or a wireless connection (e.g. using the 802.11 standard) though it should be understood that communication interface 150 can be practically any interface that enables communication to/from the system server 105.

At various points during the operation of credit transaction processing system 100, system server 105 can communicate with one or more computing devices, such as those controlled and/or maintained by one or more consumers (i.e. consumer 125) and/or merchants (i.e. merchant 115), such as remote device 102, and consumer device 101, each of which will be described in greater detail herein. Such computing devices transmit and/or receive data to/from system server 105, thereby preferably initiating maintaining, and/or enhancing the operation of the credit transaction processing system 100, as will be described in greater detail below.

It should be understood that the remote device 102 and consumer device 101 can be in direct communication with system server 105, indirect communication with system server 105, and/or can be communicatively coordinated with system server 105 through a computer network 160 such as the Internet.

It should be noted that while FIG. 1 depicts credit transaction processing system 100 with respect to a remote device 102 and a consumer device 101, it should be understood that any number of remote devices 102 and consumer devices 101 can interact with the credit transaction processing system 100 in the manner described herein. It should also be noted that while FIG. 2 depicts credit transaction processing system with respect to consumer 125 and merchant 115, it should be understood that any number of consumers and merchants can interact with the credit transaction processing system 100 in the manner described herein. It should be further understood that a substantial number of the operations described herein are initiated by and/or performed in relation to such computing devices. For example, as referenced above, such computing devices can execute applications and/or viewers which request and/or receive data from system server 105, substantially in the manner described in detail herein.

It should be further understood that while the various computing devices and machines referenced herein, including but not limited to system server 105, remote device 102, and consumer device 101 are referred to herein as individual/single devices and/or machines, in certain implementations the referenced devices and machines, and their associated and/or accompanying operations, features, and/or functionalities can be arranged or otherwise employed across any number of devices and/or machines, such as over a network connection, as is known to those of skill in the art.

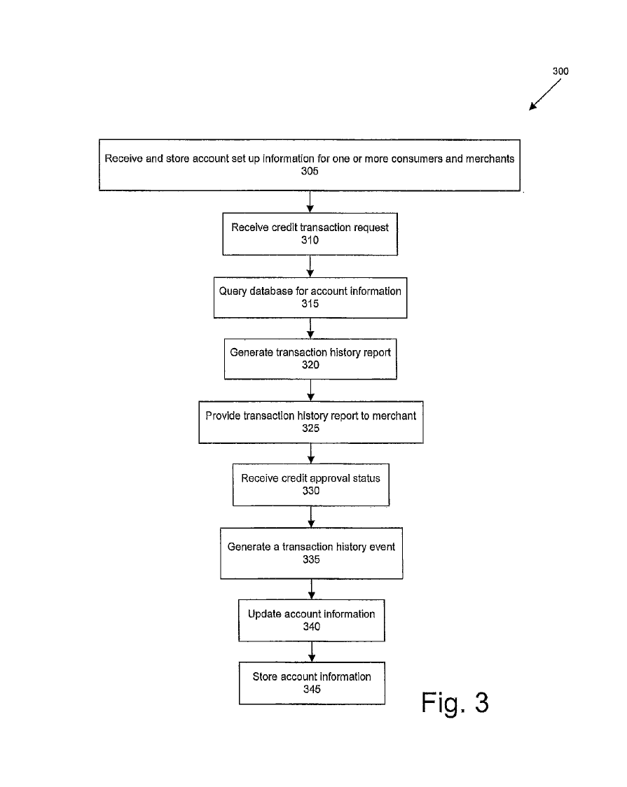

The operation of the credit transaction processing system 100 and the various elements and components described above will be further appreciated with reference to the method for facilitating an alternative payment submission as described below, in conjunction with FIG. 3.

Turning now to FIG. 3, a flow diagram illustrates a routine 300 for facilitating a credit transaction in accordance with at least one embodiment disclosed herein. It should be appreciated that several of the logical operations described herein are implemented (1) as a sequence of computer implemented acts or program modules running on credit transaction processing system 100 and/or (2) as interconnected machine logic circuits or circuit modules within the credit transaction processing system 100. The implementation is a matter of choice dependent on the requirements of the device (e.g., size, energy, consumption, performance, etc.). Accordingly, the logical operations described herein are referred to variously as operations, steps, structural devices, acts, or modules. As referenced above, various of these operations, steps, structural devices, acts and modules can be implemented in software, in firmware, in special purpose digital logic, and any combination thereof. It should also be appreciated that more or fewer operations can be performed than shown in the figures and described herein. These operations can also be performed in a different order than those described herein.

The process begins at step 305, where processor 110 executing one or more of software modules 130, including, preferably account setup module 176 and database module 172, configures system server 105 to receive account set up information from consumers and merchants wishing to make use of the services provided by the credit transaction processing system 100. This module generates accounts for the consumers and merchants and stores the information on database 180. A merchant 115 using a remote device 102 can connect to system server 105 and can provide information specific to the merchant including name, location, and banking information or other information that may be used for security purposes. The merchant 115 can also create and modify settings specific to the merchant including what type of transactions it would like to process using the system 100 and how much credit it wishes to extend to consumers with a particular credit rating. The settings set by the merchant 115 can also include how soon after the credit is extended to a consumer that the debt must be repaid by the consumer. System server 105 can generate a merchant identifier that is unique to the merchant 115. The system server 105 can also create a merchant account by associating the merchant identifier with all the information provided by the merchant 115 during the set up processes and storing this information within the database 180.

Likewise, a particular consumer 125 can connect to the system server 105 using a remote device 102 to register for the service(s) provided by system 100. The particular consumer 125 can provide a credit/debit card or bank account information to fund the account and personal information such as a picture, date of birth, place of birth and/or other personal information that can be used for security purposes. System server 105 can generate a consumer identifier that is unique to the particular consumer 125 and create an account by associating the consumer identifier with all the personal information provided by the particular consumer 125 during the set up process and storing this information on the database 180. Upon generation of an account, the system server can also create a credit profile for the particular consumer 125.

The credit profile can include one or more credit parameters such as: the total amount of credit extended to the particular consumer 125 by all merchants; the total amount of used credit; the amount of credit extended to the particular consumer 125 by individual merchants; the amount of credit used by the particular consumer 125 with each individual merchant; a credit rating for the particular consumer 125 or a combination of these parameter values. For example, the credit transaction processing system 100 can employ a star rating system where consumers who have built a reputation for good credit have a credit rating of more stars than those with poor credit. At signup, a consumer's initial credit rating can be a function of a variety of factors, for example, the consumer's FICO score or a newly registered consumer can be assigned the lowest credit rating, such as 1 star. As discussed below, the system server 105 can adjust the consumer's credit rating periodically according the consumer's use of the credit transaction processing system 100.

Then, at step 310, processor 110 executing one or more of software modules 130, including, preferably credit authorization module 170, configures system server 105 to receive a credit transaction request from a remote device 102. For example, remote device 102 can be a POS device operated by a merchant 115 in this case a Starbucks® Brand restaurant. A particular consumer 125 wishing to purchase a drink at Starbucks® on credit using the system 100 can present an NFC enabled consumer device 101 to the merchant 115, and ‘tap’ their NFC enabled device 101 against an NFC receiver connected to a remote device 102. The initiation of a credit transaction is the consumer's 125 authorization to complete the transaction with the merchant 115 on credit using the system 100. The consumer device 101 provides the consumer identifier, which is unique to particular consumer 125, to the remote device 102. The remote device 102 transmits a credit transaction request, which includes the consumer identifier, along with a merchant identifier unique to the merchant 115 and the credit amount to the system server 105.

Then, at step 315, processor 110 executing one or more of software modules 130, including, preferably, database module 172, configures system server 105 to query the database 180 for account information corresponding to the consumer identifier received at step 310. As discussed above, account information includes, among other things, historical credit transaction information, a credit profile and identification information corresponding the particular consumer 125. If database module 172 locates account information relating to the consumer identifier in database 180 the account information is provided to the credit authorization module 170 for further processing.

Then, at step 320, processor 110 executing one or more software modules 130, including, preferably, credit authorization module 170, configures system server 105 to process the information provided by the database module 172 in step 315 and generate a transaction history report corresponding to the particular consumer 125. Credit authorization module 170 can apply a filter to the broad array of information returned at step 320 to remove information that is not be relevant to the pending transaction between the particular consumer 125 and the merchant 115. In addition, credit authorization module 170 organizes the filtered account information into a format that can be transmitted and presented to the merchant 115. The transaction history report can include all or just a subset of the account information relating to the particular consumer 125. For example the transaction history report can include information about the consumer's identity, information about tabs and transactions that the particular consumer 125 has with the merchant 115, tabs with other merchants and the consumer's credit profile. The scope of information can be limited according to a variety of factors including but not limited to the merchant, time frame (i.e. from the last three months), transaction type (i.e. food purchases or drink purchases) and merchant type (i.e. restaurants, toy stores). If it is determined that the consumer does not have a tab with the merchant 115, the processor 110 executing one or more software modules 130 can configure the system server 105 to create a tab corresponding to the particular consumer 125 and merchant 115 and add the new tab to the consumer's transaction history report and update the account information stored on the database 180.

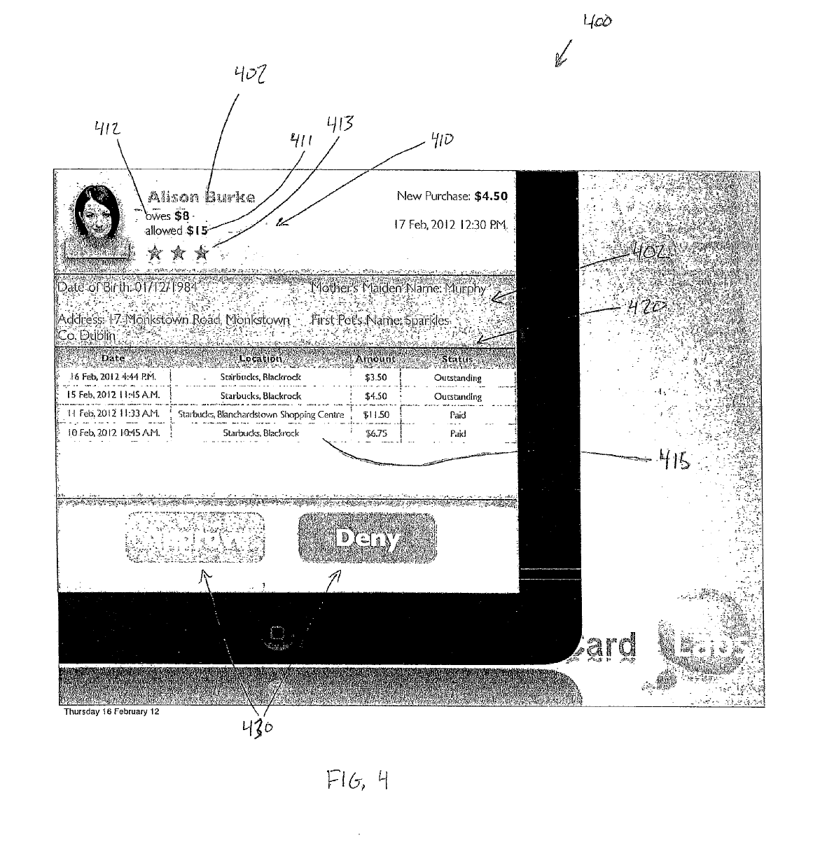

Then, at step 325, processor 110 executing one or more software modules 130, including, preferably, credit authorization module 170, can configure system server 105 to provide the transaction history report to the merchant 115. The merchant 115 can view the transaction history report and credit profile the on remote device 102. For example, FIG. 4 shows an exemplary screenshot 400 of a remote device 102 that is presented to merchant 115 during the course of a credit transaction and displaying a transaction history report. This exemplary transaction history report displays the identification information 402 of particular consumer 125 including name, date of birth, address, security questions and other information that may be used by the merchant 115 to verify the consumer's identity. Transaction history report also displays a transaction list 420, including information such as date, location, amount and payment status for each purchase with merchant 115. Transaction history report also displays the consumer's credit profile 410, which includes the total amount of credit extended 411 to the consumer by the merchant 115, the credit that they have used 412 with the merchant 115 and credit rating 413. The report 400 can be configured differently than in this exemplary embodiment.

Then at step 330, processor 110 executing one or more software modules configures system server 105 to receive a credit approval status from the merchant 125. After being presented with and reviewing the details about consumer 125 and accompanying transaction history, the merchant 125 has the discretion to approve the credit transaction, or alternatively, to decline extending credit and complete the transaction using traditional methods (i.e. cash or credit/debit card). In reference to FIG. 4, the merchant 125 can be presented with virtual buttons 430 on the remote device 102 to either accept or deny the transaction.

Then, at step 335, processor 110 executing one or more software modules 130, including, preferably, credit authorization module 170, configures system server 105 to generate a transaction history event. A transaction history event is a record of the transaction between the particular consumer 125 and the merchant 115 that was either completed or denied. The transaction history event can include the information included in the credit transaction request (i.e. consumer identifier, merchant identifier, credit amount) and the approval status (i.e. whether the merchant approved or denied the credit transaction).

Then, at step 340, processor 110 executing one or more software modules 130, including, preferably, credit authorization module 170, configures system server 105 to update the account. The transaction history is updated by saving the transaction history event generated at step 330 to the account associated with the particular consumer 125 and this is available to other merchants that check the credit status of the particular consumer 125. In addition, if the merchant 115 approved the transaction, the credit profile will be updated to reflect an increase in the amount of credit extended by merchant 115 that is used by the particular consumer 125. For every transaction, whether it is an approval or denial, the consumer's credit rating can be updated by the system 100 to reflect either the decrease in available credit or the denial of credit by the merchant 115.

Then, at step 345, processor 110 executing one or more software modules 130, including, preferably, database module 172, configures system server 105 to store the updated account in the database in a conventional manner.

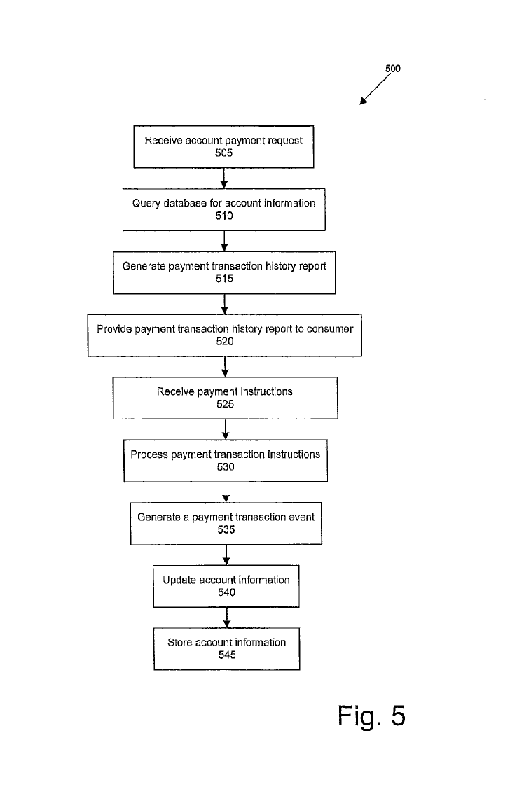

Turning now to FIG. 5, a flow illustrating a method for facilitating a credit transaction in accordance with at least one embodiment disclosed herein. The process begins at step 505, where processor 110 executing one or more software modules 130, including, preferably, payment processing module 174, will configure the system server 105 to receive an account payment request from a consumer 125 using a remote device 102. The account payment request can include a consumer identifier corresponding to the consumer 125. At some point during a consumer's membership to the service provided by the system 100, the consumer 125 can elect to pay or can be required to pay a portion or all of his/her outstanding tabs with one or more merchants. Optionally, the consumer can enable the system 100 to automatically pay the balance of all open tabs as they are due to remove the requirement to pay accounts manually and avoid late payment penalties. The consumer can connect with system server 105 through a remote device 102.

At step 510, processor 110 executing one or more of software modules 130, including, preferably, database module 172, configures system server 105 to query the database 180 for account information corresponding to the consumer identifier received at step 505. If any account information relating to the consumer is found it is provided to the payment module 172 for further processing.

At step 515, processor 110 executing one or more software modules 130, including, preferably, payment module 170, configures the system server 105 to process the account information provided by the database module 172 in step 510 and generate a payment transaction history report corresponding to the consumer 125. The payment transaction history report can include all or just a subset of the available information relating to the consumer 125. For example the transaction history report can include consumer identification information, information about open tabs and transactions that the consumer 125 has with one or more merchants and can also include the consumer's credit profile.

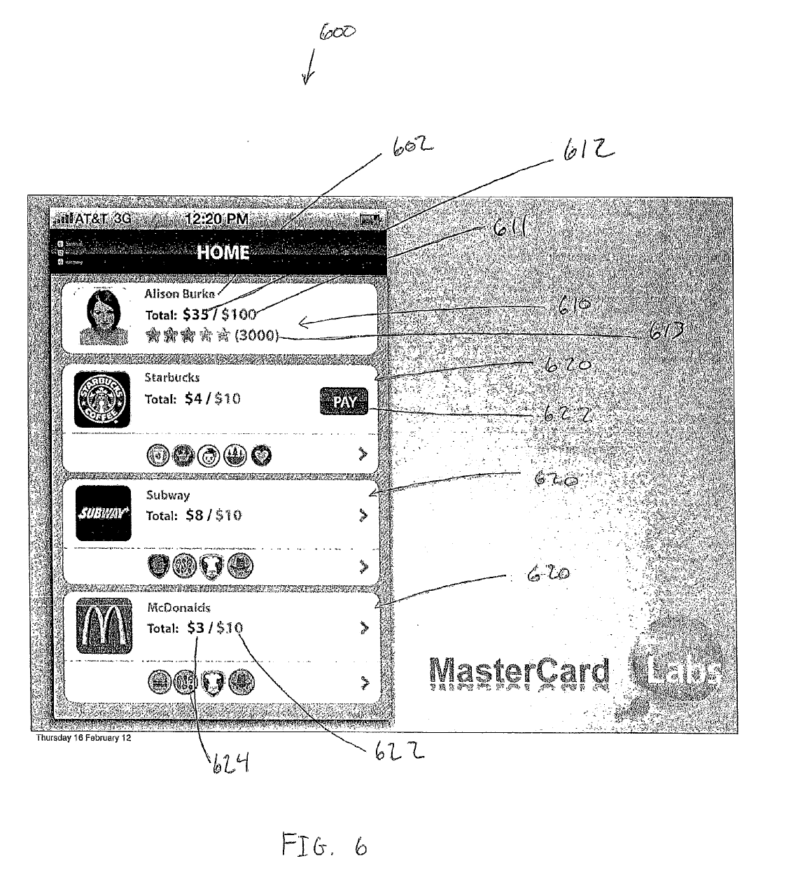

At step 520, processor 110 executing one or more software modules 130, including, preferably, payment module 170, can configure system server 105 to provide the payment transaction history report to the consumer 125. The consumer 125 can view the transaction history report and credit profile the on remote device 102. For example, FIG. 6 shows an exemplary screenshot of a remote device 102 that is presented to a consumer 125 during payment and displaying a payment transaction history report 600. This exemplary transaction history report can display the consumer's name 602 and credit profile 610. Credit profile 610 can include the total amount of available credit 611 and the amount of credit extended 612 to the consumer, and a credit rating 613. The payment transaction history displayed on the consumer device can also include the open tabs 620 that the consumer has. For example, the payment transaction history report 600 depicts three open tabs 620 with merchants: Starbucks®, Subway® and McDonalds®. For each merchant tab 620 the total credit limit with that merchant is displayed 622 as is the amount of used credit 624. The report 600 can be configured differently and provide an interface to the particular consumer having the same functionality.

At step 525, processor 110 executing one or more software modules 130, including, preferably, payment module 170, configures system server 105 to receive payment instructions. In reviewing the transaction history 600 on remote device 102, the consumer 125 can chose to repay the debt accrued on any or all of the open tabs 620. In reference to FIG. 6, this can be achieved by clicking the virtual “pay” button 622 displayed in transaction report 600 on remote device 102, thereby generating payment instructions that are transmitted to the system server 105. Payment instructions can include consumer identifier, the merchant identifier corresponding to the open tab 620 that the consumer would like to pay money towards, and the amount of money that the consumer would like to pay.

At step 530, processor 110 executing one or more software modules 130, including, preferably, payment module 170, configures database server 105 to process payment instructions. Processing payment instructions can include retrieving the credit/debit information for the consumer and the banking information for the merchant 115 which are stored on the database 180. The system server 105 can also be configured to generate a request to a payment gateway with the customer and merchant banking information and payment amount. The payment gateway forwards the request to the bank that issued the consumer's credit/debit card. The issuing bank can accept the request and the payment gateway can then send a request to the merchant's bank, transferring funds. At this point the payment attempt can be either successfully completed or denied by the consumer or merchant bank.

At step 535, processor 110 executing one or more software modules 130, including payment module 174 configures system server 105 to generate a payment transaction event. The payment transaction event is a record of the payment transaction between the consumer and the merchant that was either completed or denied. The transaction history event can include the consumer identifier, merchant identifier, payment amount and the status of the payment (i.e. whether it was approved or denied).

At step 540, processor 110 executing one or more software modules 130, including, preferably, payment module 174, configures the system server 105 to update the account information associated with the consumer. The account information is updated by saving the payment transaction event generated at step 525 to the account. For example, if the payment is approved, the account will be updated to reflect an increase in the amount of credit now available to the consumer by the merchant whose account was paid. If the payment is denied for some reason, such as insufficient funds, the denial can also be saved in the transaction history.

For all payment transactions, whether it results in an approval or denial of payment, the processor 110 executing one or more software modules 130, configures the system server 105 to update the consumer's credit profile accordingly. By example, if the payment request is accepted and the debt is paid within the time period specified by the merchant 115 the consumer's 125 credit limit is increased according to the amount given on credit and repaid. In addition on time payment can result in an increase in the consumer's credit rating. If the payment request is denied and/or the consumer does not pay the debt within the time period specified by the merchant their credit rating can be decreased. This can accumulate periodically so that outstanding debt will continually reduce the consumer's 125 credit rating. If a consumer 125 does not pay the debt within the time period specified by the merchant 115 system 100 can assign a black mark against the consumer's credit rating which will reduce the consumer's credit rating and prevent credit from being extended to the consumer by the merchant

Then, at step 545, processor 110 executing one or more software modules 130, including, preferably, database module 172, can store the updated account in the database.

It should be noted that the system 100 is not limited to the use of a near field communication enabled consumer device 101 to initialize a credit transaction. The system 100 can be utilized to facilitate a credit transaction anywhere four key pieces of information can be provided to the system 100 including the merchant identifier, the consumer identifier, the amount of the credit transaction and the authorization of the consumer.

Consumer device 101 can also be a Bluetooth enabled device and can transmit the consumer identifier and authorization to the remote device 102 (i.e. a merchant POS device) that is similarly Bluetooth enabled. The merchant identifier and credit amount are provided by the merchant's POS device.

Initialization of the credit transaction can also be completed using visual codes. For example, consumer device 101 can be a simple QR code or bar code. The code can be read by remote device 102 such as a merchant's POS device. By reading the code, the remote device 102 retrieves the consumer identifier and authorization. Optionally, the authorization is provided separately by the consumer. The merchant identifier and credit amount are provided by the merchant's remote device 102. The QR code or bar code is configured to identify the consumer in a conventional manner.

Alternatively the consumer and not the merchant can control the remote device 102. For example, remote device 102 can be a smart phone with QR code or barcode scanning ability. The consumer 125 can use remote device 102 to read a QR code or bar code that is provided by a merchant 115, thus retrieving the merchant identifier and the amount of the credit transaction. In this scenario, the consumer identifier and consumer authorization are provided by the consumer operated remote device 102 (i.e. smart phone).

In some instances a consumer device 101 is unnecessary. For example, initialization of the credit transaction can be completed using only a remote device 102 that is a self-service check-out device at a store. The self-service check-out device allows a consumer 115 to enter their consumer identifier and provide authorization using only the self service checkout device (e.v. a keyboard or touch-sensitive interface thereof) which also automatically provides the merchant identifier and transaction amount.

Initialization of the credit transaction can also be completed using only a remote device 102 that is a mobile telephone with text message capability. By example, a particular consumer 115 using the mobile telephone can transmit the credit transaction request via text message. The message can include the merchant identification and the credit amount in the text body; the phone number associated with the message can be the consumer identification and transmission of the message can constitute an authorization to charge the consumer.

Initialization of the credit transaction can also be completed using a widget in a retail website/application that is being displayed through an internet enabled remote device 102 being used by a consumer. The widget in the website/application can allow the consumer to enter his/her consumer identification and authorization and the merchant ID and transaction amount can be provided by the retail website/application.

At this juncture, it should be noted that although much of the foregoing description has been directed to systems and methods for facilitating credit transactions, the systems and methods disclosed herein can be similarly deployed and/or implemented in scenarios, situations, and settings far beyond the referenced scenarios. It can be readily appreciated that credit transaction processing system 100 can be effectively employed in practically any scenario in which a transaction is being made between one or more parties, whether in person or via electronic methods.

It is to be understood that like numerals in the drawings represent like elements through the several figures, and that not all components and/or steps described and illustrated with reference to the figures are required for all embodiments or arrangements.

Thus, illustrative embodiments and arrangements of the present systems and methods provide a computer implemented method, computer system, and computer program product for facilitating credit transactions. The flowchart and block diagrams in the figures illustrate the architecture, functionality, and operation of possible implementations of systems, methods and computer program products according to various embodiments and arrangements. In this regard, each block in the flowchart or block diagrams can represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the present invention, which is set forth in the following claims.

What is claimed is:

1. A credit transaction processing system having one or more processors configured to interact with a computer-readable storage medium and execute one or more software modules stored on the storage medium, comprising:
a database module configured to: maintain account information stored in a database for one or more of a plurality of consumers including the particular consumer; generate a credit transaction event; update the account information corresponding to the particular consumer; and store the account information in the database;
an authorization module configured to: receive a credit transaction request from a remote computing device in response to an action by the particular consumer, the credit transaction request comprising a consumer identifier corresponding to the particular consumer, a merchant identifier corresponding to one or more of a plurality of merchants and a credit request amount; generate a transaction history report corresponding to the particular consumer in response to the credit transaction request; provide the transaction history report to the remote computing device; and receive an approval status for the credit transaction request.

2. The system of claim 1, further comprising:
a payment module configured to: receive an account payment request from a consumer computing device, the account payment request comprising the consumer identifier corresponding to the particular consumer; generate a transaction history report corresponding to the particular consumer in response to the account payment request;
provide the transaction history report to the consumer computing device; receive payment instructions relating to the transaction history report; process the payment instructions; and
wherein the database module is further configured to: generate an account payment event; update the account information corresponding to the particular consumer;
and store the transaction history in the database.

3. The system of claim 1, wherein the remote computing device is a point of sale device at a merchant's location.

4. The system of claim 1, wherein the remote computing device is configured to read a consumer device provided by the particular consumer.

5. The system of claim 4, wherein the consumer device is a near field communication device.

6. The system of claim 1, wherein the authorization module generates a credit profile by:
calculating the particular consumer's credit rating; calculating the allowable amount of credit extended to the particular consumer; and calculating the amount of credit already extended to the particular consumer by the merchant corresponding to the merchant identifier.

7. The system of claim 6, wherein the authorization module calculates the particular consumer's credit rating by applying an algorithm that is a function of the total amount of credit that has been extended to the particular consumer.

8. The system of claim 6, wherein the authorization module calculates the particular consumer's credit rating by applying an algorithm that is a function of the payment history of the particular consumer.

9. A computer implemented method for facilitating a credit transaction using a computing device, the method comprising:
receiving a credit transaction request at the computing device from a remote computing device in response to an action by a consumer, the credit transaction request comprising a consumer identifier corresponding to the consumer, a merchant identifier corresponding to one or more of a plurality of merchants and a credit request amount corresponding to the credit transaction;
querying a database for account information corresponding to the consumer;
generating a transaction history report corresponding to the consumer;
providing the transaction history report to the remote computing device;
receiving an approval status corresponding to the credit transaction from the remote computing device;
generating a credit transaction event;
updating the account information according to the credit transaction event; and
storing the transaction history in the database.

10. The method of claim 9, further comprising:
receiving an account payment request from a remote computing device, the account payment request comprising a consumer identifier corresponding to the consumer;
providing a transaction history corresponding to the consumer in response to the account payment request;
receiving payment instructions relating to the transaction history; and
processing the payment instructions;
generating a payment transaction event;
updating the account information according to the payment transaction event; and
storing the account information in the database.

11. The method of claim 9, wherein generating a credit profile includes:
calculating the consumer's credit rating;
calculating the allowable amount of credit extended to the consumer; and
calculating the amount of credit already extended to the consumer by the merchant corresponding to the merchant identifier.

12. The method of claim 11, wherein calculating the consumer credit rating further comprises applying an algorithm that is a function of the total amount of credit that has been extended to the consumer.

13. The method of claim 11, wherein calculating the consumer credit rating further comprises applying an algorithm that is a function of the payment history of the consumer.

14. The method of claim 10, wherein the account payment request is automatically generated on a regularly occurring interval as set by the consumer.
